(19) United States
(12) Patent Application Publication
(10) Pub. No.: US 2012/0325629 A1
(43) Pub. Date: Dec. 27, 2012

(54) Tilt Switch

(76) Inventors: Xiao-Feng Li, New Taipei (TW); Li-Jun Xu, New Taipei (TW); Ming-Han Lin, New Taipei (TW)

(21) Appl. No.: 13/165,793

(22) Filed: Jun. 22, 2011

(51) Int. Cl. H01H 35/02

(52) U.S. Cl. 200/61.52

(57) ABSTRACT

A tilt switch includes an insulating housing having a receiving chamber and a connecting cavity between which a ring-shaped step is formed, electrical terminals each having a support arm of platy shape inserted upward into the connecting cavity, a switching ball made of conductive materials and rollably placed in the receiving chamber, and an insulating cover removably covered on the insulating housing to restrain the switching ball in the insulating housing. The support arms are arranged at regular intervals around the center axis of the connecting cavity. The ring-shaped step has a top face substantially perpendicular to two vertical periphery surfaces of the connecting cavity and the receiving chamber. The switching ball needs to roll over the ring-shaped step having a hard span when the tilt switch changes working states thereof among a closed state, a shorted state and an open state.

### BACKGROUND OF THE INVENTION

1. Field of the Invention

The present invention relates to a switch, and more particularly to a tilt switch.

2. The Related Art

A traditional tilt switch includes an insulating housing, a plurality of electrical terminals assembled in the insulating housing, a switching ball rollably placed in the insulating housing, and an insulating cover covered on the insulating housing to restrain the switching ball in the insulating housing. An inclined guiding slope of a ring shape is provided in the insulating housing for propping the switching ball when the tilt switch is at a closed state by means of simultaneously contacting with the electrical terminals, and guiding the switching ball to roll by means of tilting the tilt switch sideward so as to disconnect the switching ball from the electrical terminals and realize an open state of the tilt switch.

However, in the condition of the tilt switch having a finite size, it is difficult to ensure the tilt switch steadily at the closed state or the open state only by means of the inclined guiding slope, and the switching ball is apt to randomly roll even if the tilt switch is tilted at a very little angle. As a result, the tilt switch has a bad operational reliability. Furthermore, each of the electrical terminals has one distal end which electrically contacts with the switching ball designed as a pyramid shape for making point contact with the switching ball. In order to meet a strength demand, the electrical terminal is designed to have a relatively larger cross-section. As a result, a great deal of materials is needed and manufacture cost of the electrical terminal is accordingly increased.

### SUMMARY OF THE INVENTION

An object of the present invention is to provide a tilt switch including an insulating housing. The insulating housing has a receiving chamber in an upper portion thereof and a connecting cavity in a lower portion thereof. The connecting cavity is coaxially connected with the receiving chamber and smaller than the receiving chamber in diameter to accordingly form a ring-shaped step between two vertical periphery surfaces of the connecting cavity and the receiving chamber. The ring-shaped step has a top face substantially perpendicular to the two vertical periphery surfaces of the connecting cavity and the receiving chamber. A plurality of electrical terminals each has a support arm of platy shape penetrating upward through the insulating housing to stretch into the connecting cavity, and a soldering arm extending sideward from a bottom end of the support arm to be suspended under the insulating housing. The support arms are arranged at regular intervals around the center axis of the connecting cavity. A switching ball is made of conductive materials and rollably placed in the receiving chamber of the insulating housing. An insulating cover is removably covered on the insulating housing to seal up the receiving chamber and restrain the switching ball in the insulating housing. The switching ball needs to roll over the ring-shaped step having a hard span when the tilt switch changes working states thereof among a closed state which is realized by the switching ball further projecting into the connecting cavity to simultaneously electrically connect with free ends of the support arms, a shorted state which is realized by tilting the tilt switch to make the switching ball contact with three of the electrical terminals, and an open state which is realized by tilting the tilt switch to disconnect the switching ball from at least two of the electrical terminals.

As described above, the switching ball of the tilt switch of the present invention needs to roll over the step which has a harder span when the tilt switch changes the working states thereof among the closed state, the shorted state and the open state. Furthermore, the support arm of the electrical terminal can be punched from a sheet material so that makes the strength of the support arm easily improved by means of widening the support arm. So manufacture materials and cost of the electrical terminal are effectively reduced.

### BRIEF DESCRIPTION OF THE DRAWINGS

The present invention will be apparent to those skilled in the art by reading the following description thereof, with reference to the attached drawings, in which:

FIG. 1 is an exploded perspective view of a tilt switch in accordance with an embodiment of the present invention;

FIG. 2 is an assembled perspective view of the tilt switch of FIG. 1;

FIG. 3 is a cross-sectional view of an insulating housing of the tilt switch of FIG. 1;

FIG. 4 is a cross-sectional view showing the tilt switch at a closed state; and

FIG. 5 is a cross-sectional view showing the tilt switch at an open state.

### DETAILED DESCRIPTION OF THE PREFERRED EMBODIMENT

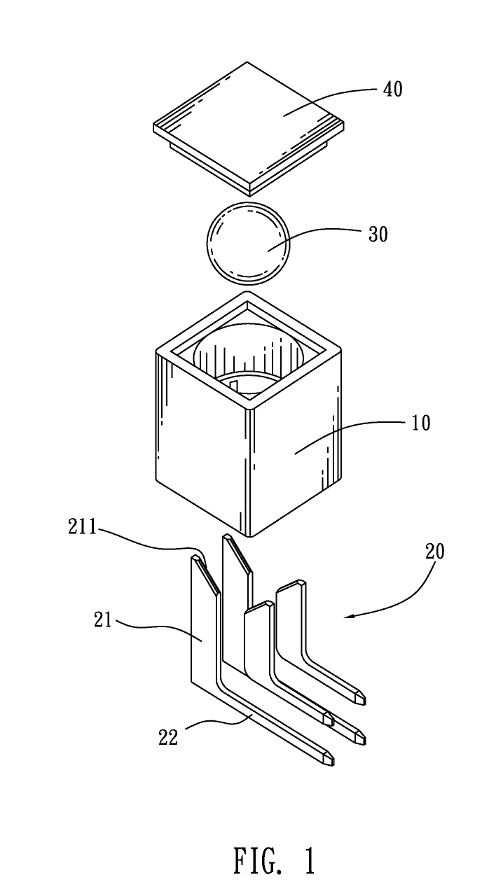

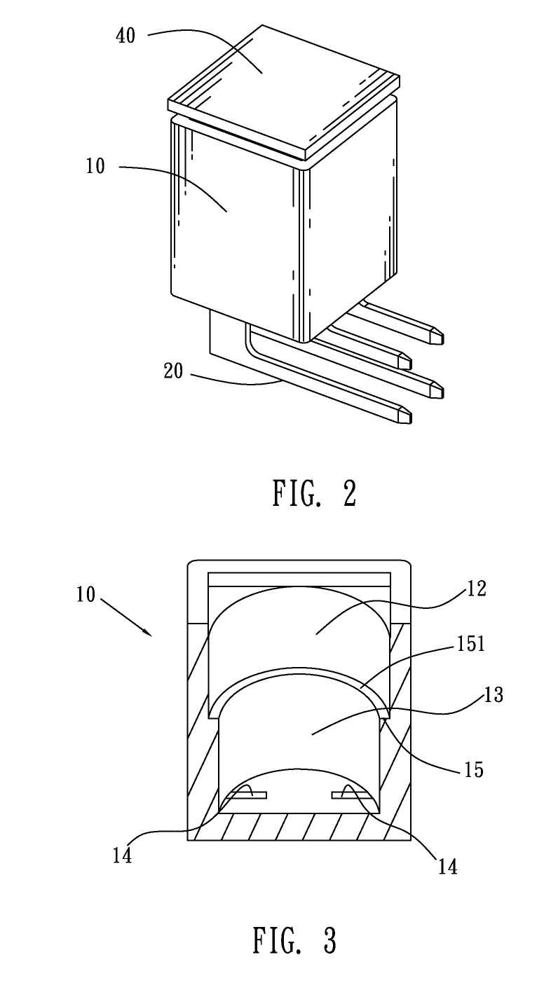

With reference to FIG. 1 and FIG. 2, a tilt switch according to an embodiment of the present invention includes an insulating housing 10, four electrical terminals 20 assembled in the insulating housing 10, a switching ball 30 rollably placed in the insulating housing 10, and an insulating cover 40 removably covered on the insulating housing 10 to restrain the switching ball 30 in the insulating housing 10.

Referring to FIG. 1 and FIG. 3, the insulating housing 10 is of a rectangular case shape with a columned receiving chamber 12 in an upper portion thereof and a columned connecting cavity 13 in a lower portion thereof. The receiving chamber 12 has a top opened freely. The connecting cavity 13 has a top connected with a bottom of the receiving chamber 12 and is coaxial with the receiving chamber 12. The connecting cavity 13 is smaller than the receiving chamber 12 in diameter to accordingly form a ring-shaped step 15 between two vertical cylindrical surfaces of the connecting cavity 13 and the receiving chamber 12, wherein the ring-shaped step 15 has a top face 151 perpendicular to the two vertical cylindrical surfaces of the connecting cavity 13 and the receiving chamber 12. A bottom side of the connecting cavity 13 is provided with a plurality of inserting holes 14 each extending vertically to penetrate through the insulating housing 10.

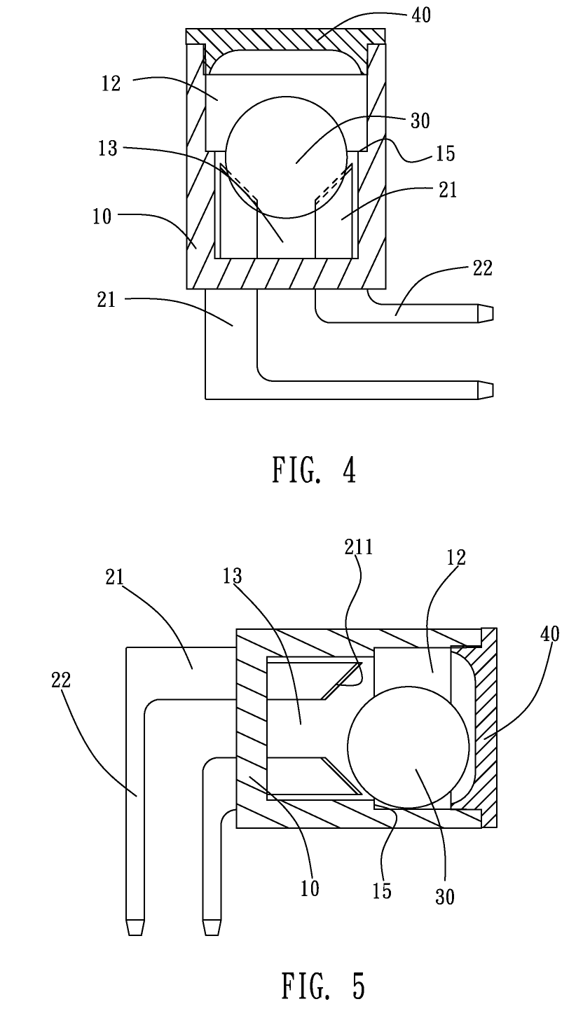

Referring to FIG. 1 and FIG. 4, each of the electrical terminals 20 is of substantial L-shape, and has a support arm 21 of platy shape and a soldering arm 22 of rectangular-column shape perpendicular to each other. A free end of the support arm 21 is designed with a contact slope 211. The support arms 21 of the electrical terminals 20 are inserted upward into the inserting holes 14 to make the contact slopes 211 projected into the connecting cavity 13, with the soldering arms 22 of the electrical terminals 20 being suspended under the insulating housing 10. The support arms 21 are arranged at regular intervals around the center axis of the connecting cavity 13, and the contact slopes 211 are inclined towards the center axis of the connecting cavity 13 from top to bottom.

The switching ball 30 is made of conductive materials and rollably placed in the receiving chamber 12 of the insulating housing 10, wherein the switching ball 30 can be supported by the ring-shaped step 15 to further project into the connecting cavity 13 so as to electrically contact with the contact slopes 211 of the electrical terminals 20. The insulating cover 40 is covered on the insulating housing 10 to seal up the receiving chamber 12, so as to restrain the switching ball 30 in the insulating housing 10.

Referring to FIG. 4, the tilt switch is uprighted to realize a closed state, by means of the switching ball 30 projecting into the connecting cavity 13 to simultaneously electrically connect with the four contact slopes 211 of the four electrical terminals 20, wherein the switching ball 30 can be steadily held among the contacts slopes 211 of the support arms 21 to realize a steady connect with the electrical terminals 20.

Referring to FIG. 5, the tilt switch is tilted sideward to drive the switching ball 30 to roll over the step 15 into the receiving chamber 12 under the guidance of the contact slopes 211 so as to disconnect the switching ball 30 from the electrical terminals 20. In the embodiment, the tilt switch is at a shorted state when the switching ball 30 makes only contact with three of the electrical terminals 20, and realizes an open state if only the switching ball 30 is disconnected from at least two of the electrical terminals 20.

As described above, the switching ball 30 of the tilt switch of the present invention needs to roll over the step 15 which has a harder span when the tilt switch changes working states thereof among the closed state, the shorted state and the open state. Furthermore, the support arms 21 of the electrical terminals 20 utilize the contact slopes 211 to steadily hold the switching ball 30 thereamong when the tilt switch is at the closed state. So, the working states of the tilt switch are not easily changed so that further improves operational reliability of the tilt switch. Moreover, the support arm 21 of the electrical terminal 20 can be punched from a sheet material so that makes the strength of the support arm 21 easily improved by means of widening the support arm 21. So manufacture materials and cost of the electrical terminal 20 are effectively reduced.

What is claimed is:

1. A tilt switch, comprising:
an insulating housing having a receiving chamber in an upper portion thereof and a connecting cavity in a lower portion thereof, the connecting cavity being coaxially connected with the receiving chamber and being smaller than the receiving chamber in diameter to accordingly form a ring-shaped step between two vertical periphery surfaces of the connecting cavity and the receiving chamber, the ring-shaped step having a top face substantially perpendicular to the two vertical periphery surfaces of the connecting cavity and the receiving chamber;
a plurality of electrical terminals each having a support arm of platy shape penetrating upward through the insulating housing to stretch into the connecting cavity, and a soldering arm extending sideward from a bottom end of the support arm to be suspended under the insulating housing, the support arms being arranged at regular intervals around the center axis of the connecting cavity;
a switching ball made of conductive materials and rollably placed in the receiving chamber of the insulating housing; and
an insulating cover removably covered on the insulating housing to seal up the receiving chamber and restrain the switching ball in the insulating housing,
wherein the switching ball needs to roll over the ring-shaped step having a hard span when the tilt switch changes working states thereof among a closed state which is realized by the switching ball further projecting into the connecting cavity to simultaneously electrically connect with free ends of the support arms, a shorted state which is realized by tilting the tilt switch to make the switching ball contact with three of the electrical terminals, and an open state which is realized by tilting the tilt switch to disconnect the switching ball from at least two of the electrical terminals.

2. The tilt switch as claimed in claim 1, wherein the free end of the support arm is designed with a contact slope, the contact slopes of the electrical terminals are inclined towards the center axis of the connecting cavity from top to bottom for steadily holding the witching ball thereamong when the tilt switch is at the closed state, and guiding the roll of the switching ball when the tilt switch is tilted sideward.
